(19) United States
(12) Patent Application Publication
(10) Pub. No.: US 2008/0089059 A1
(43) Pub. Date: Apr. 17, 2008

(54) Lamp holder with a set-in replaceable adaptor as combination to rate single end pin-based compact fluorescent bare lamp

(76) Inventor: Da Chang, Syosset, NY (US)

Correspondence Address: DA-KUANG CHANG, 87 Kathleen Dr., Syosset, NY, 11791, US

(21) Appl. No.: 11/999,915

(22) Filed: Dec. 10, 2007

Related U.S. Application Data
(63) Continuation-in-part of application No. 11/149,505, filed on Jun. 2, 2005, now abandoned.

(51) Int. Cl. F21S 4/00

(52) U.S. Cl. 362/217

(57) ABSTRACT

There is multiple ballast and many self-ballast sockets or lamp holders in market to connect the power to rate pin based compact fluorescent lamp. Haven't seen any these products can be easily replaced by user. This innovation is relating to a lamp holder with having an easier replaceable integral ballasted adaptor as combination. The design of the present invention is applicable to use GX10q lamp holder & GX10q lamp based compact fluorescent bare lamp. The purpose and special feature of this GX10q lamp holder combination being applied to fixture which shall use single end pin-based compact fluorescent lamp source, the ballasted adaptor is easy to have replacement, particularly when such design of GX10q combination being adopted in recessed downlight and attachment light kits for ceiling fan, the lamp will not fall to loose and with solid security and convenience accordingly.

### CROSS-REFERENCES TO RELATED APPLICATIONS

This application is a continue-in-part of application Ser. No. 11/149,505, filed Jun. 2, 2005, the entire disclosure of which is hereby incorporated herein by reference in this application.

### STATEMENT REGARDING FEDERALLY SPONSORED RESEARCH OR DEVELOPMENT

N/A

### REFERENCE TO A “MICROFICHE APPENDIX”

N/A

### BACKGROUND OF THE INVENTION

1. Field of the Invention

The present invention relates to a fluorescent lamp holder, more particularly, relates to a replaceable adaptor which set-in inner housing of the lamp holder as a combination. The internal of this adaptor have electronic ballast is able to rated the single end compact fluorescent bare lamp.

2. Description of the Related Art

Generally, The exists single end pin-based compact fluorescent bare lamp shall have plug-in with a same standard pin-based socket or may call lamp holder, which shall extension connect with a ballast to rated fluorescent the question mark is, this rating ballast to connect with pin-based socket shall hardwired with wire or integral of the socket one or an other. In case the incandescent has burned, just replace bulb, how about fluorescent lighting kit if ballast burned how to replace it if which is self-ballasted inner of the socket or hardwired in the fixture?

The GX10q lamp base is one kind of pin-based lamp base that in compliance with the standardized of IEC 61-2L 7005-84-2. It is able locked the lamp in place on a GX10q lamp holder is measures up on standard of IEC. In detail, there are two brackets configuration set on each side of the GX10q lamp base, and two hookers are set on the GX10q lamp holder of entrance that relative to the brackets, in order a compact fluorescent bare lamp is usage a GX10q lamp base which able install into the GX10q lamp holder, set-in and turn the lamp for 35 degree clock wise, the lamp will be locked on the lamp holder by the engagement between the brackets of the lamp base and the hookers on the GX10q lamp holder, accordingly, if the lamp is burned, just uncoupling the engagement of the brackets form the hookers, the lamp will be release. When the electronic ballast is burned, if it is self-ballasted type socket as one unit, the whole socket need be replaced. If the ballast is integrated of an adaptor it is set-in the empty housing of lamp holder as two piece then just replacement this ballasted adaptor, this designation can be allow user to replaced burned either one of lamp or adaptor that will save and more convenience. So the self-ballasted socket to rate fluorescent is one kind of waste the part when circuit of ballast is burned then need be replaced and destroyed socket or whole fixture; and further to replacement of this self-ballasted socket will increase the cost, and also raise burden to the environment.

### DETAILED DESCRIPTION OF THE INVENTION

The object of the present invention is to provide a pin-based lamp holder combination that the inner of this lamp holder have a housing coupled an adaptor is able to replacement it alone by user, thus to overcome the defects of waste and environment pollute that takes by the replacement of the self-ballasted pin-based socket.

The technical solution of the present invention is to provide a pin-based lamp holder which hollow as housing will be accepting the a replaceable ballasted adaptor as combination to rate single end compact fluorescent bare lamp, this lamp shall usage that same standard lamp base matching that lamp holder. The lamp holder is connecting with a line voltage power supply, a connection portion is provided on the inner side of the housing for replaceable connecting with the electronic ballasted adaptor; an input electrode for connecting the line voltage power supply with the input end of the ballasted adaptor is provided on the upper end of the housing unit, and an output high frequency current for connecting the output end of the ballasted adaptor with the lamp base is locked on the place that having two hookers on the lower entrance of the lamp holder unit.

Preferably, the lamp hold unit is a housing, the input line voltage is sets on the upper end of the lamp holder, and the lower end is an opening as entrance; the output electrode is the output end on the ballasted adaptor; both the outside surface of the adaptor and the inner surface of the housing of the lamp holder are provided with at least one tenon and at least one groove respectively, each tenon and groove are matching with each other, and the tenon is slide on the groove along the axes of the adaptor sleeve.

Preferably, at least two pairs of tenons and grooves that matching with each other are provided on the surface of the adaptor and the inner surface of housing of the lamp holder respectively, and each pair of tenon and groove are un-symmetrically arranged on the circle of the adaptor with other pair of tenon and groove. And the length of each pair of tenon and groove along the axes of the adaptor is different from other pair of tenon and groove. Each pair of tenon and groove is symmetrically arranged on the circle of the adaptor with other pair of tenon and grooves. The length of the shorter pair shall shortly than the longer pair about half.

The advantages of this pin-based lamp holder combination of the present invention are, accepting the replaceable ballasted adaptor inner of the lamp holder first, and install a single end compact fluorescent bare lamp which shall have to use GX10q lamp base standard and locking it on the hookers of the GX10q lamp holder, and thus the lamp unit and the ballasted adaptor can be replaced separately; and at the same time, as the input and output are set on the upper end and lower end of the replaceable ballasted adaptor unit for connecting with high frequency current to quad-pins on bare lamp, it rates a compact fluorescent lamp working normally. So, at the condition of only the ballast is burned, this invention allow user to replacement adaptor alone and do not needs to replace the whole self-ballasted socket, this is in favor of saving materials and decreasing electronic rubbishes, lighten the burden on the environment.

### BRIEF DESCRIPTION OF THE DRAWINGS

FIG. 1 is the structure view of the lamp holder combination of the present invention when applying on a recessed downlight kit;

FIG. 2 is the exploded view of lamp holder combination with replace able ballasted adaptor to rate an integral reflector compact fluorescent lamp as in FIG. 1;

FIG. 3 is the structure view of the lamp holder combination of the present invention when applying on a portable working light;

FIG. 4 is the exploded view of lamp holder combination with replace able ballasted adaptor to rate an integral reflector compact fluorescent lamp as in FIG. 3;

FIG. 5 is the structure view of the lamp holder combination of the present invention when applying on a portable desk light;

FIG. 6 is the exploded view of lamp holder combination with replace able ballasted adaptor to rate single end spiral compact fluorescent bare lamp as in FIG. 5.

### DETAILED DESCRIPTION OF PREFERRED EMBODIMENTS

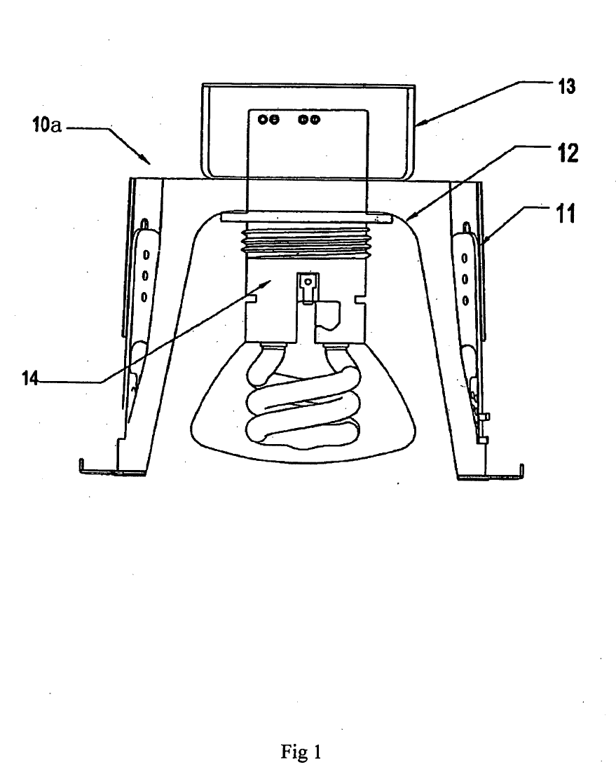

As shown in FIG. 1, the lamp holder combination to rate single end integral reflector compact fluorescent lamp of the present invention is applying on recessed downlight unit, for detail, the a recessed downlight kit 10a comprises a junction box 13, includes a frame 11 and a trim 12, and a lamp holder combination 14, the 14 is depositing the inner of the trim 12 in center. The combination 14 traversing the top portion of the trim 12 and fit with the junction box 13 that setting on the top portion of the frame 11, thus the whole combination is fixed on the frame 11. By fixing the frame 11 on ceiling place, the whole recessed kit 10a can be fixed thereon also.

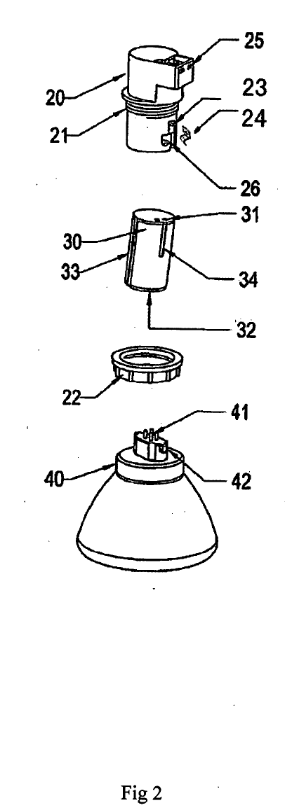

As shown in FIG. 2, the connection between the lamp holder and the lamp base of the recessed kit is in accordance with the standardized of IEC 61-2L 7005-84-2, the lamp base and the lamp holder are GX10q standard, back viewed in FIG. 1, GX10q lamp holder combination 14 respectively. The combination 14 includes a lamp holder 20, an external screw thread 21 is set on the outer surface of the lamp holder 20, and a securing ring 22 that having an inner screw thread matching with the external screw thread 21. When the lamp holder 20 extending fitted on the recessed downlight kit through the trim 12 and top portion of the frame 11 through the junction box 13, the securing ring 22 screwing on the external screw thread 21 from below, thus the lamp holder 20 is be fixed on the frame 11 as a recessed downlight kit unit 10a. The lower end of the lamp holder 20 is a hollow cylinder such as housing with an opening entrance on lower end. The two steel splint fasteners 24 will mount through two small holes 23, are provided on the outer surface of the lamp holder 20. When lamp holder in base-up the fasteners 24 are for holding ballasted adaptor 30 in place won't fall for the lamp later a moment to install and locked in place of hookers 26. The size of entrance and the hookers 26 of lamp holder are met with the standard of IEC 61-2L 7005-84-2, so they can be engaged with the buckles 42 of the GX10q lamp base. Two AC wire connection holes 25 are set on the top end of the lamp holder for connecting with line voltage power source, and a touching piece that extending to the chamber is also provided thereon, for jointing the outer line voltage source into the housing. A ballasted adaptor unit 30 is provided inside the housing also, the replaceable adaptor unit 30 can be accepted inset into the housing of the lamp holder exactly. A ballast is deposited inner of this adaptor, and two input electrode 31 are provided on the upper end of the adaptor, the input electrode 31 are for line voltage connecting with the input of the ballast's circuit, when the adaptor is inserting into the housing, two input electrode 31 contacts with the touching piece fitly, so the outer line voltage source will be conducted with the inner ballast's circuit. Also, the output high frequency current 32 with have four spots are provided on the lower end of the adaptor for connecting with the output end of the inner ballast's circuit. In order the ballasted adaptor has insert into the housing in place from the lower entrance of the lamp holder, and fastened the lamp that having usage GX10q lamp base, both are in accordance with the standard of IEC 61-2L 7005-84-2, then shall turn 35 degree clock wise, to ensure the two buckles 42 set each side of the lamp base will be in place of two hookers 26 and locked, the four output electrode 32 are contacting with the quad pins 41 of the lamp justly to form an effective electric connection, so the high frequency current are connected with the lamp rated by ballasted adaptor 30, and the lamp can be light properly.

If the reflector lamp 40 is burned, the lamp can be replaced directly; and if the ballast is burned, just taking release the lamp first, and taking out the ballasted adaptor from the self-powered housing of the GX10q lamp holder, and replace it alone. As for this configuration, it's unnecessary to replace the unburned lamp and other parts such as self-ballasted socket or integral lamp, thus reduced the producing of electronic rubbish.

Advantageously, in the above embodiment, the lower portion of the adaptor can be set as a un-assemblable top cover, the ballast is sealing internal of adaptor; also, the lower portion of the adaptor can be set as an opening, the out end of the ballast is acting as the output high frequency of the adaptor to contact with the quad pins of the bare lamp.

As the arrangement of the touching pieces of the ballasted adaptor's input and output ends are not always symmetrical, the arrangement of the input and output electrodes of the adaptor are un-symmetrical too; so the engagement between the adaptor and the lamp has an orientation in the direction of the circle, in order to ensure proper contacting between the input electrode and the touching quad pins outer the lamp base by proper engaging of the adaptor and lamp holder, a pair of tenon and groove that matching with each other is provided on the inner surface of the housing of that lamp holder and outer surface of the adaptor respectively. The tenon can sliding on the groove along the axes direction of the adaptor, thus when the adaptor is inserting into the lamp holder, only if the tenon is aimed at the groove, the tenon can be slide into the groove along the axes direction of the adaptor, and at the same time to ensure the adaptor can not rotate inside the housing of that lamp holder, thus to secure proper contacting between the input line voltage supply and the touching piece.

Advantageously, in the above embodiment, the tenon can be set on the outer surface of the adaptor, and the groove is set on the inner housing surface of the housing. The tenon and groove between the adaptor and the housing of that lamp holder can be set as two pairs, the angle between the two pairs of tenon and groove is less than 180°, so the two pairs of tenon and groove are un-symmetrically arranged on the circle of the adaptor, and only when the adaptor turning to a certain angle, each tenon can insert into the matched groove, and thus the adaptor be inserted into the housing of that lamp holder to make sure proper contact of the input line voltage and the touching piece. For the same reason, the tenon and groove between the adaptor and the housing of that lamp holder can be set as a plentiful of pairs, so far as the combination of each pair of tenon and groove is un-symmetrically arranged on the circle of the adaptor, the input line voltage supply can properly contact with the touching piece.

When the tenon and groove between the adaptor and the housing of that lamp holder are set as two pairs, and these two pairs are symmetrically arranged on the circle of the adaptor, the length of the first pair of tenon and groove along the axes direction of the adaptor is different with the length of the second pair, as shown in FIG. 2. And in a preferred embodiment of the present invention, the length of the first pair of tenon and groove 34 is only half of the second pair of tenon and groove 33. With this kind of configuration, once the tenon matching with the groove properly, the adaptor can insert into the bottom of the housing of that lamp holder, and the input line voltage can properly contact with the touching piece and match with each other, otherwise, the replaceable adaptor can not entirely insert into the bottom of the housing of that lamp holder, and the lamp usage same standard lamp base can not installed with the lamp holder combination to got rate. For the same reason, when the tenon and groove between the adaptor and the housing of that lamp holder is set as a plentiful of pairs, and each pair of tenon and groove is symmetrically arranged on the circle of the adaptor, so far as the length of one pair of tenon and groove is different from others, the input line voltage will properly contact with the touching piece. Of course, when a plentiful pairs of tenons and grooves are un-symmetrically arranged on the circle of the adaptor, the length of each pair can be different also.

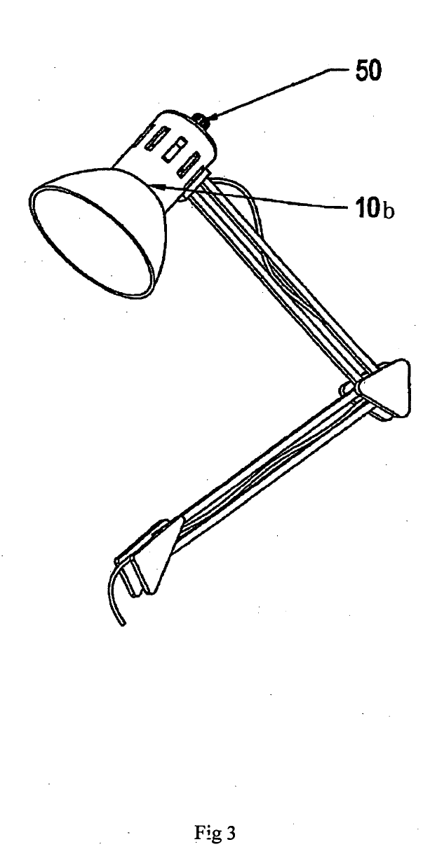

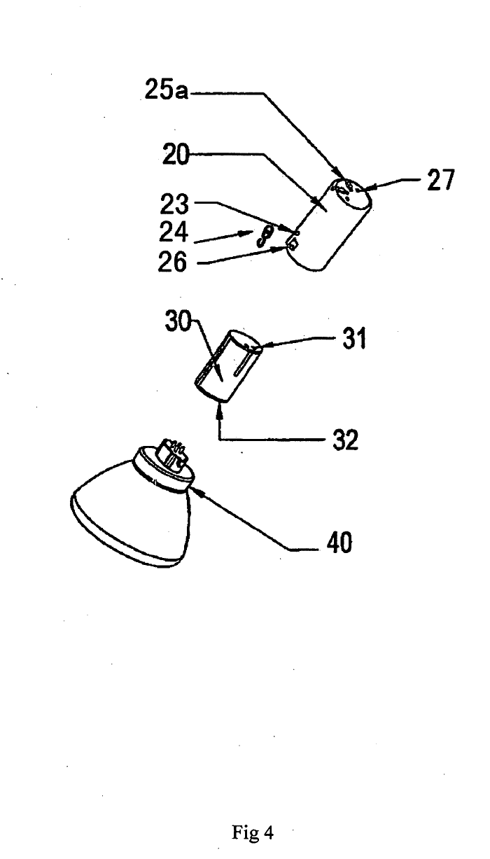

As shown in FIGS. 3 and 4, the lamp holder combination to rate single end reflector fluorescent lamp of the present invention is applying on a portable working light. The working light kit with have a shade comprises a pedestal 10b as FIG. 1 recessed downlight kit 10a, a lamp holder combination 20 and a reflector lamp 40. The combination 20 includes a ballasted adaptor 30, when this lamp holder two AC wire connection holes 25a are set on the top end of the lamp holder for connecting the outer line voltage into a hollow housing of the lower portion of the lamp holder. The two steel splint fasteners 24 will mounted through two small holes 23 as holders are provided on the outer surface of the lamp holder 20, when lamp holder in base-up the fasteners 24 are for holding ballasted adaptor 30 inserted in place won't fall for lamp later a moment to install and locked in place of hookers 26. Similarly, the adaptor is inserted into the housing of that lamp holder and accepted therein. Adaptor 30 that having a ballast's circuit is internal, and two input line voltage 31 and output high frequency current 32 with have four spots are provided on the upper and lower ends of the adaptor respectively, when the adaptor 30 is inserted into the housing of lamp holder, the input line voltage will electric connect the input end of the adaptor with the AC electrode on the upper end of the lamp holder 25a; when the reflector lamp 40 with usage GX10q lamp base is set-in to opening of the lower entrance of the lamp holder, turn 35 degree clock wise and locked in the place 26, the quad pins of lamp will connect the output end of the adaptor with rating by adaptor, then the line voltage source be supplied to the ballasted adaptor through the connection and treatment to rate the lamp. Further, two holes 27 are set on the upper end of the lamp holder for mounted the lamp holder on working light as a whole lighting kit 10b with use two screws, for example, by using a bolt drill through the two connection holes 27. An ON/Off switch 50 is set on the top of the lamp holder also, to turn the power ON/Off for lamp holder. If the adaptor is burned, just release the lamp first and take the adaptor out from the combination and replacement a new.

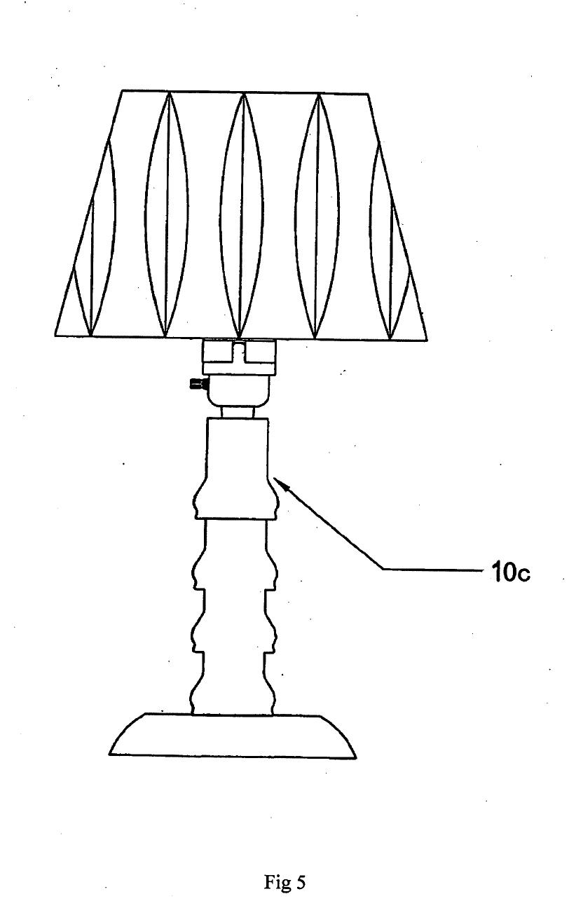

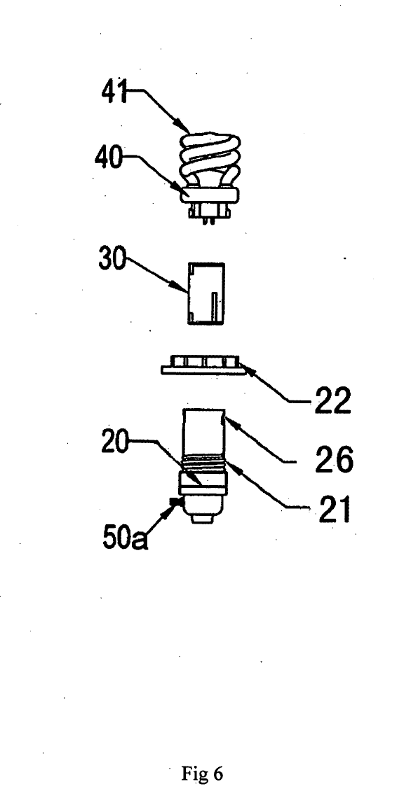

As shown in FIGS. 5 and 6, the lamp holder combination to rate single end spiral compact fluorescent bare lamp of the present invention is applying on a portable desk light. The desk light comprises a pedestal 10c as FIG. 1 recessed downlight kit 10a, the spiral bare lamp 41 having use GX10q lamp base 40. The lamp holder 20 includes replaceable adaptor unit 30 as combination, an outer screw thread 21 is set on the surface of the lamp base, and a securing ring 22 having an inner screw thread that matching with the outer screw thread 21 is provided also, the securing ring 22 is using for secure the lamp shade on the lamp holder 20 on the surface of the top portion of the lamp holder, a connecting structure that in accordance with the criterion of IEC 61-2L 7005-84-2 is provided thereon, so the spiral bare lamp 41 with usage GX10q lamp base 40 can be replaceable with turn-in the upper entrance of the lamp holder 20 and locked in place of 26. Further, the structures of the hollow housing of lamp holder and the adaptor are similar as of above mention FIG. 2, 4 embodiments, so the ballasted adaptor 30 can be replaced separately and conveniently with release lamp first. On the lower portion of the lamp holder, a dimmer and turn-off switch 50a which able to dimming the fluorescent is provided, and this portion can be build-in a daylight sensor unit when the lamp holder combination may assembling as outdoor fixture.

In summary, when the lamp holder combination of the present invention is applied in different wattage lamps and lanterns, the connection or fixation method between the lamp holder and the frame of the lamps includes but not limited by the above mentioned embodiments; also, the connection manner between the lamp holder and the lamp includes but not limited by the above mentioned embodiments, the preferred connecting structure is in accordance with the standard of IEC 61-2L 7005-84-2, so, easy for replacing. In using, if the lamp holder having a housing for accepting the replaceable ballasted adaptor, and the adaptor unit is unfixed inserting into the lamp holder, for example, by a tenon and a groove to fixation, is full into the arrange of protection of the present invention.

1. A lamp holder with a set-in replaceable adaptor as combination to rate single end pin-based compact fluorescent bare lamp having a housing for accepting the replaceable ballasted adaptor, the lamp holder is connecting with a line voltage power supply; a connection portion is provided on the inner side of the housing for replaceable connecting with the line voltage, wherein:
a connection portion is provided on the inner side of the housing for connecting with the electronic ballasted adaptor;
an input electrode for connecting the line voltage power supply with the input end of the ballasted adaptor is provided on the upper end of the housing unit, and
an output high frequency current for connecting the output end of the ballasted adaptor with the lamp base is locked on the place that having two hookers on the lower entrance of the lamp holder unit.

2. The lamp holder combination to rate single end compact fluorescent bare lamp as in claim 1, wherein the lamp hold unit is a housing, the input line voltage is set on the upper end of the lamp holder, and the lower end is an opening as entrance; the output electrode is the output end on the ballasted adaptor; both the outside surface of the adaptor and the inner surface of the housing of the lamp holder are provided with at least one tenon and at least one groove respectively, each tenon and groove are matching with each other, and the tenon is slide on the groove along the axes of the adaptor sleeve.

3. The lamp holder combination to rate single end compact fluorescent bare lamp as in claim 2, wherein at least two pairs of tenons and grooves that matching with each other are provided on the outside surface of the ballasted adaptor and the inner surface of the housing of that lamp holder respectively, and each pair of tenon and groove is un-symmetrically arranged on the circle of the adaptor with other pair of tenon and groove.

4. The lamp holder combination to rate single end compact fluorescent bare lamp as in claim 3, wherein at least two pairs of tenons and grooves that matching with each other are provided on the outside surface of the ballasted adaptor and the inner surface of the housing of the lamp holder respectively, and the length of each pair of tenon and groove along the axes of the adaptor is different from other pair of tenon and groove.

5. The lamp holder combination to rate single end compact fluorescent bare lamp as in claim 4, wherein each pair of tenons and groove is symmetrically arranged on the circle of the adaptor with other pairs of tenons and grooves. the length of the shorter pair of tenon and groove is half of the length of the longer pair of tenon and groove.

6. The lamp holder combination to rate single end compact fluorescent bare lamp as in claim 5, wherein the ballasted adaptor working position is between of lamp hold and lamp, the adaptor's input electrode and output contacts are between lamp holder & lamp them shall using the touching piece fitly then adaptor will able to removed from the housing.
